(19) United States
(12) Patent Application Publication
(10) Pub. No.: US 2026/0304101 A1
(43) Pub. Date: Oct. 1, 2026

(54) AMBIENT INTERNET OF THINGS (AIoT) DEVICE AVAILABILITY & REACHABILITY DETECTION & PREDICTION

(71) Applicant: InterDigital Patent Holdings, Inc., Wilmington, DE (US)

(72) Inventors: Mohamad Kenan Al-Hares, Canterbury (GB); Michael Starsinic, Newtown, PA (US); Guanzhou Wang, Brossard (CA); Anuj Sethi, Ottawa (CA); Alec Brusilovsky, Downingtown, PA (US)

(73) Assignee: InterDigital Patent Holdings, Inc., Wilmington, DE (US)

(21) Appl. No.: 19/092,689

(22) Filed: Mar. 27, 2025

(51) Int. Cl. H04W 8/22; G16Y 10/75; G16Y 20/20; G16Y 40/10; H04W 64/00

(52) U.S. Cl. CPC H04W 8/22; H04W 64/006; G16Y 10/75; G16Y 20/20; G16Y 40/10

(57) ABSTRACT

A first network device comprises a processor configured to receive a first inventory request, wherein the first inventory request may identify an ambient internet of things (AIoT) device and/or location information associated with the AIoT device. The processor may be configured to send a message to an AIoT data management (ADM) function to determine whether a second network device may be permitted to trigger an inventory procedure with the AIoT device, receive, from the AIoT ADM function, an indication that the second network device may be permitted to trigger the inventory procedure with the AIoT device, receive, from the AIoT ADM function, historical information associated with the AIoT device, determine a first radio access network (RAN) node for accessing the AIoT device based on the historical information associated with the AIoT device, and send a second inventory request to the first RAN node.

### BACKGROUND

An application function (AF) may send an inventory request to one or more AIoT devices. AIoT device(s) may be unavailable for a certain duration (e.g., due to lack of power). The AIoT device unavailability may be due to the AIoT device and/or the reader movement (e.g., mobility) which may make reaching the AIoT device by the reader limited. AIoT device(s) may be unreachable via a first AIoT random access network (RAN) due to a change in the location of the AIoT device(s) and/or reader. The AIoT device(s) may become unresponsive when they have low power and/or are without available power.

### SUMMARY

A first network device may comprise a processor. The processor may be configured to receive a first inventory request, wherein the first inventory request may identify an ambient internet of things (AIoT) device and/or location information associated with the AIoT device (e.g., step 306 in FIG. 3A). The processor may be configured to send a message to an AIoT data management (ADM) function to determine whether a second network device may be permitted to trigger an inventory procedure with the AIoT device (e.g., step 308 in FIG. 3A). The processor may be configured to receive, from the AIoT ADM function, an indication that the second network device may be permitted to trigger the inventory procedure with the AIoT device (e.g., step 308 in FIG. 3A). The processor may be configured to receive, from the AIoT ADM function, historical information associated with the AIoT device. The historical information may include, for example, information about previous attempts to perform the inventory procedure with the AIoT device (e.g., step 308 in FIG. 3A). The processor may be configured to determine a first radio access network (RAN) node for accessing the AIoT device based on the historical information associated with the AIoT device (e.g., step 326 in FIG. 3A and step 328 in FIG. 3B). The processor may be configured to send a second inventory request to the first RAN node. The second inventory request may include, for example, an identifier associated with the AIoT device (e.g., step 334 in FIG. 3B). The location information may indicate one or more locations where the AIoT device is expected to be located.

The location information may include, for example, a cell identifier associated with where the AIoT device is expected to be located, an AIoT RAN node identifier associated with where the AIoT device is expected to be located, and/or a geographical information associated with where the AIoT device is expected to be located.

The historical information associated with the AIoT device may include, for example, information associated with a location of the AIoT device when a successful inventory procedure was performed and/or a time at which the successful inventory procedure was performed.

The historical information associated with the AIoT device may include, for example, information associated with a location of the AIoT device where an attempt to perform the inventory procedure was unsuccessful and/or a time at which the unsuccessful inventory procedure was attempted.

The historical information associated with the AIoT device may include, for example, information associated with properties of the AIoT device. The information associated with properties of the AIoT device may include an indication of how long it should take the AIoT device to recharge its energy storage after the inventory procedure and/or after any event where the AIoT device communicates and/or perform action.

The processor may be configured to perform an inventory request generation with the AIoT ADM function. The inventory request generation may include, for example, one or more of last time the AIoT device was recorded unavailable, last time the AIoT device was recorded available, whether the AIoT device is available and/or unavailable for certain period(s) of times, information about average response time of the AIoT device, and/or list of reader(s) used to reach the AIoT device previously (e.g., step 308 in FIG. 3A).

The processor may be configured to send a third inventory request to a second RAN node (e.g., step 314 in FIG. 3A). The processor may be configured to receive a message from the second RAN node, wherein the message from the second RAN node may indicate that the AIoT device is not responding (e.g., step 324 in FIG. 3A).

The processor may be configured to predict when the AIoT device will be available, wherein the prediction may be based on the historical information and/or an availability information received in the inventory request generation from the AIoT ADM function (e.g., step 326 in FIG. 3A).

The processor may be configured to send an indication to a network exposure function (NEF). The indication may include, for example, an AIoT device identity and/or an application function (AF) request ID (e.g., step 330 in FIG. 3B).

A first network device may be configured to perform a method that includes one or more of the following steps. The method may include receiving a first inventory request, wherein the first inventory request may identify an ambient internet of things (AIoT) device and/or location information associated with the AIoT device (e.g., step 306 in FIG. 3A). The method may include sending a message to an AIoT data management (ADM) function to determine whether a second network device may be permitted to trigger an inventory procedure with the AIoT device (e.g., step 308 in FIG. 3A). The method may include receiving, from the AIoT ADM function, an indication that the second network device may be permitted to trigger the inventory procedure with the AIoT device (e.g., step 308 in FIG. 3A). The method may include receiving, from the AIoT ADM function, historical information associated with the AIoT device. The historical information may include, for example, information about previous attempts to perform the inventory procedure with the AIoT device (e.g., step 308 in FIG. 3A). The method may include determining a first radio access network (RAN) node for accessing the AIoT device based on the historical information associated with the AIoT device (e.g., step 326 in FIG. 3A and step 328 in FIG. 3B). The method may include sending a second inventory request to the first RAN node. The second inventory request may include, for example, an identifier associated with the AIoT device (e.g., step 334 in FIG. 3B). The location information may indicate one or more locations where the AIoT device is expected to be located.

The location information may include, for example, a cell identifier associated with where the AIoT device is expected to be located, an AIoT RAN node identifier associated with where the AIoT device is expected to be located, and/or a geographical information associated with where the AIoT device is expected to be located.

The historical information associated with the AIoT device may include, for example, information associated with a location of the AIoT device when a successful inventory procedure was performed and/or a time at which the successful inventory procedure was performed.

The historical information associated with the AIoT device may include, for example, information associated with a location of the AIoT device where an attempt to perform the inventory procedure was unsuccessful and/or a time at which the unsuccessful inventory procedure was attempted.

The historical information associated with the AIoT device may include, for example, information associated with properties of the AIoT device. The information associated with properties of the AIoT device may include an indication of how long it should take the AIoT device to recharge its energy storage after the inventory procedure and/or after any event where the AIoT device communicates and/or perform action.

The method may include performing an inventory request generation with the AIoT ADM function. The inventory request generation may include, for example, one or more of last time the AIoT device was recorded unavailable, last time the AIoT device was recorded available, whether the AIoT device is available and/or unavailable for certain period(s) of times, information about average response time of the AIoT device, and/or list of reader(s) used to reach the AIoT device previously (e.g., step 308 in FIG. 3A).

The method may include sending a third inventory request to a second RAN node (e.g., step 314 in FIG. 3A). The method may include receiving a message from the second RAN node, wherein the message from the second RAN node may indicate that the AIoT device is not responding (e.g., step 324 in FIG. 3A).

The method may include predicting when the AIoT device will be available, wherein the prediction may be based on the historical information and/or an availability information received in the inventory request generation from the AIoT ADM function (e.g., step 326 in FIG. 3A).

The method may include sending an indication to a network exposure function (NEF). The indication may include, for example, an AIoT device identity and/or an application function (AF) request ID (e.g., step 330 in FIG. 3B).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flowchart illustrating an example inventory procedure according to an embodiment.

FIGS. 3A and 3B are a flowchart illustrating an example procedure for AIoT device detection and prediction according to an embodiment.

### DETAILED DESCRIPTION

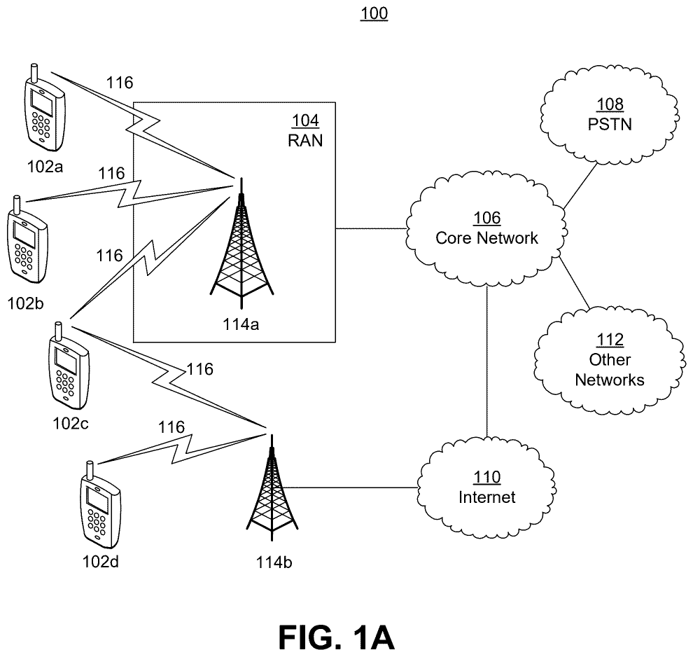

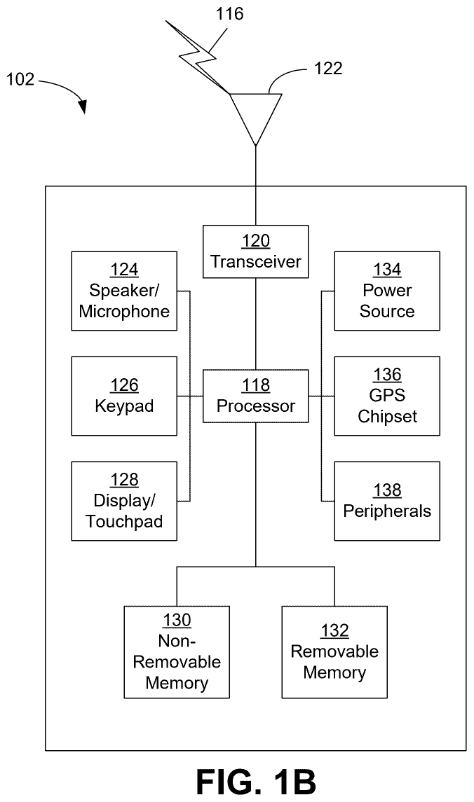

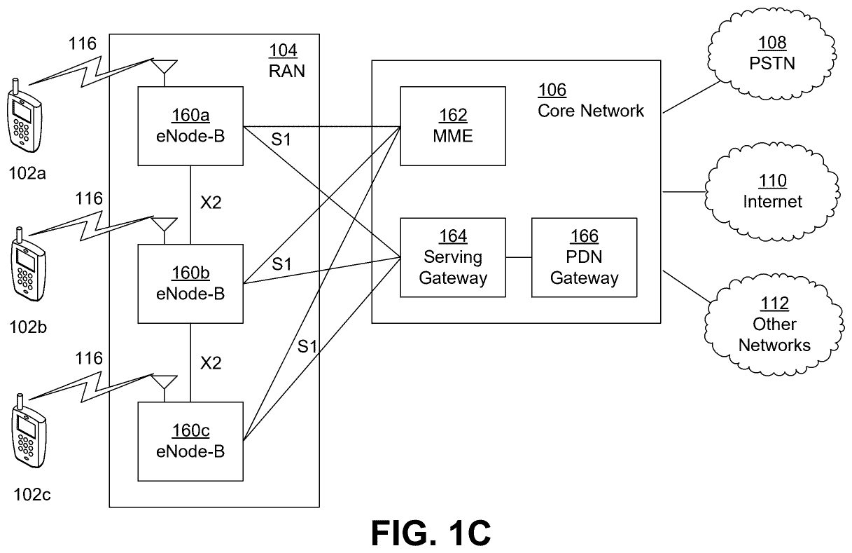

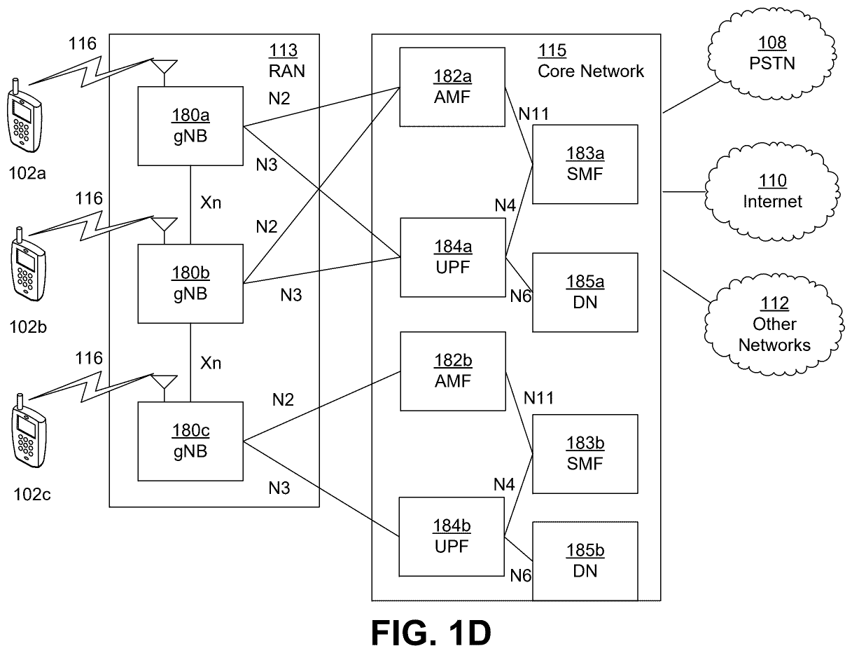

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel.

The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Discussed herein may be some examples which allow the mobile network to inform the application function (AF) regarding the AIoT device availability state and/or decide whether another inventory procedure must be performed. Some examples may allow the mobile network to determine whether another AIoT random access network (RAN) node may be used to increase the chance of receiving a response from the AIoT device.

An AF may send an inventory request to one or more AIoT devices. AIoT device(s) may be unavailable for a certain duration (e.g., due to lack of power). The AIoT device unavailability may be due to the AIoT device and/or the reader movement (e.g., mobility) which may make reaching the AIoT device by the reader limited. AIoT device(s) may be unreachable via a first AIoT (RAN) due to a change in the location of the AIoT device(s) and/or reader. The AIoT device(s) may become unresponsive when they have low power and/or are without available power.

The AF request may be associated with a certain application, wherein this application might have certain requirements. For example, the application may require a maximum response delay. The AF may need to know the expected availability time of the AIoT device and/or the expected amount of time required for the AIoT device to respond to the request.

It may be desirable to define a system & procedures that may allow a network to inform the AF regarding AIoT device ability. It may be desirable to define a system & procedures that may allow a network to respond to the AF request and the AIoT device expected availability in terms of time and location.

An AIoT function (AIoTF) may be implemented. In some examples, AIoTF may perform the following actions. For example, the AIoTF may receive an inventory request from the AF. The message may have an AIoT device identity, AF identity, AF request ID and AF request requirements (e.g., maximum response delay duration). The message may include the AIoT location information.

For example, the AIoTF may receive availability and/or reachability information from the AIoT data management (ADM). The received availability information may include last time the device was recorded unavailable. The received availability information may include last time the device was recorded available. The received availability information may include whether the device was unavailable for certain period of times. The received availability information may include information about certain pattern(s) of availability for the AIoT device available in the ADM. The received availability information may include information about average response time of the AIoT device. The received reachability information may include a list of reader(s) used to reach the AIoT device before. The list may include, for example, the reader(s) identities and/or reader(s) location(s).

For example, the AIoTF may send an inventory request to the AIoT RAN1. The message may have the AIoT device identity. The message may have values associated with the request timer. The AIoTF may use the AIoT location information that was received from the AF to determine what AIoT RAN (e.g., AIoT RAN1) to send this inventory request to.

For example, the AIoTF may receive an inventory report from the AIoT RAN1. The report may indicate that the AIoT device is not responding. For example, the AIoTF may be triggered to analyze the AIoT device availability and/or alternative routes to reach the AIoT device. The analysis may include, for example, checking the received stored and/or observed AIoT device availability information that was received from the ADM as discussed above to predict when the device is available next. The analysis may include checking if any availability pattern for the AIoT device may be available in the received information from the ADM as discussed above to predict the next availability of the AIoT device. The analysis may include checking if availability information from previous requests and/or periods received as discussed above may be used to predict the next availability of the AIoT device. The analysis may include checking if the received information as discussed above has information regarding the average response time and/or response time of previous requests. This may be used by the AIoTF to predict the average response time of the current request. The analysis may include comparing the expected average time of response with the received maximum response delay parameter from the AF. The analysis may include checking if provided information by the ADM as discussed above has identity(s) of recent reader(s) used to communicate with the AIoT device. The identity(s) of recent reader(s) may be used by the AIoTF to select an alternative reader, if AIoTF decides to second an inventory request to the AIoT device.

For example, the AIoTF may decide the next action regarding the AF request associated with the AIoT device. Decisions may include one or more of the following. For instance, the decision may include that the AIoT device is expected to be unavailable for a period exceed the communicated maximum response delay by the AF. The decision may include that the AIoT device is expected to be available shortly and/or within a period less than the maximum response delay and the AIoT can initiate immediately a second inventory request. The decision may include that the AIoT device might be available through a different reader. The decision may include that the AIoT RAN and/or AIoTF needs to initiate a second inventory request through different reader. For instance, since the AIoT RAN1 may indicate that the AIoT device did not respond, the AIoTF may use the information that the AIoTF received from the ADM to determine what other AIoT RAN node(s) may be used to reach the AIoT Device and/or at what times the AIoT Device might be available.

For example, the AIoTF may notify the network exposure function (NEF) regarding the next action on the AF request. For instance, the message may have the AIoT device identity and/or AF request ID. The message may have an indication that the AIoT device is not expected to fulfil the request requirements. The message may have an indication that the AIoTF may perform a second inventory procedure with the AIoT device (e.g., via a different AIoT RAN node).

For example, the AIoTF may send an inventory request to the newly selected AIoT RAN. The message may have the AIoT device identity, AF identity and/or AF request ID. The AIoTF may receive the AIoT device response from the newly selected AIoT RAN. The message may have the AIoT device response and/or AF request ID. The AIoTF may update the AIoT device information in the ADM. The AIoTF may send the ADM, for example, AIoT device availability, such as last availability time. The AIoTF may send the ADM response time. The AIoTF may send the ADM reachability information, such as the ID of the loT RAN used to reach the AIoT device. In some examples, the ADM may store this information.

An inventory procedure may be implemented. In some examples, the AIoTF may receive an inventory request from an AF. The inventory request may identify what device needs to be inventoried and/or may include location information. The location information may indicate the location(s) where the AIoT device is expected to be located. The location information may be cell identifiers, AIoT RAN node identifiers, and/or geographical information.

In some examples, the AIoTF may query the ADM to check if the AF is permitted and/or authorized to trigger an inventory procedure with the AIoT device. The ADM may respond with an indication that the AF is permitted to trigger the inventory procedure. The ADM may provide historical information to the AIoTF. The historical information may include information about previous attempts to perform an inventory procedure with the AIoT device. For instance, the historical information may include information about the AIoT device's location when a successful inventory procedure was performed and the times at which the successful inventory procedure was performed. The historical information may include information about the locations where an attempt to perform an inventory procedure was unsuccessful and/or the times at which the unsuccessful inventory procedure was attempted. The historical information may include information about the properties of the AIoT device. For example, the information about the properties of the device may include how long it should take the AIoT device to recharge its energy storage after an inventory procedure and/or after any event where the AIoT Device communicates and/or performs action.

In some examples, the AIoTF may use the location information to determine the identity of one or more AIoT RAN nodes and/or may attempt to initiate an inventory procedure via the one or more AIoT RAN nodes. The AIoTF may receive an indication that the attempt to perform the inventory procedure via the one or more AIoT RAN nodes was unsuccessful.

In some examples, the AIoTF may indicate to the AF that at least one initial attempt to perform the inventory was unsuccessful and that the AIoTF may perform one or more additional attempts.

In some examples, the AIoTF may use the historical information to determine the identity of one or more other AIoT RAN nodes and/or may attempt to initiate an inventory procedure via the one or more other AIoT RAN nodes. The AIoTF may receive an indication that the attempt to perform the inventory procedure via one of the other AIoT RAN nodes was successful.

In some examples, the AIoTF may send information about the successful and unsuccessful inventory attempts to the ADM. The transmitted information may include the location of successful and/or unsuccessful attempts. The location information may be the identity of the AIoT RAN nodes. The transmitted information may include the time and/or date of the successful inventory attempt.

In some examples, the AIoTF may send the result of the inventory operation to the AF and/or may send the location of the AIoT device when the inventory operation was successful to the AF. The location information may be the identity of the AIoT RAN node that was used to perform the inventory procedure with the device. Additionally and/or alternatively, the location information may be geographical information that the AIoTF may determine based on the identity of the AIoT RAN and/or information that was received from the AIoT RAN node.

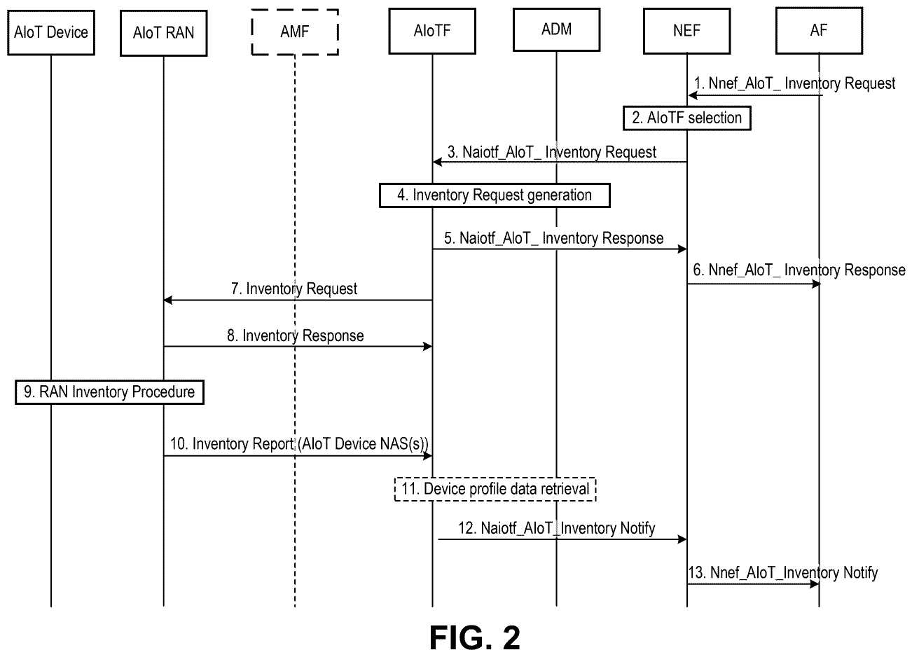

FIG. 2 shows an example inventory procedure 200. The inventory procedure may involve an AF requesting that the network perform an inventory procedure with one or more devices. The network may include an AIoT RAN, an AIoTF, an ADM and a NEF. The AF may send an inventory request to the AIoTF through the NEF. After receiving the inventory request from the AF, the AIoTF and ADM may generate the inventory request. The inventory request generation may include the AIoTF checking the AF request parameters. If the AF parameters check is successful, the AIoT may generate a correlation ID corresponding to the AF service operation request. When the request is generated, the AIoTF may send the generated inventory request through the AIoT RAN to the AIoT device. When the AIoT device responds, the AIoTF may validate the response using the provided AIoT device profile information by the ADM and/or may forward the response to the AF through the NEF.

In some examples described herein, the mobile network may be allowed to inform the AF regarding the AIoT device availability state. In some examples described herein, the network may determine whether a second inventory procedure should be performed after a first inventory procedure fails. Examples described herein may explain how the network may determine whether a second inventory procedure should be attempted via an AIoT RAN that is different than the AIoT RAN that was used in the first inventory procedure.

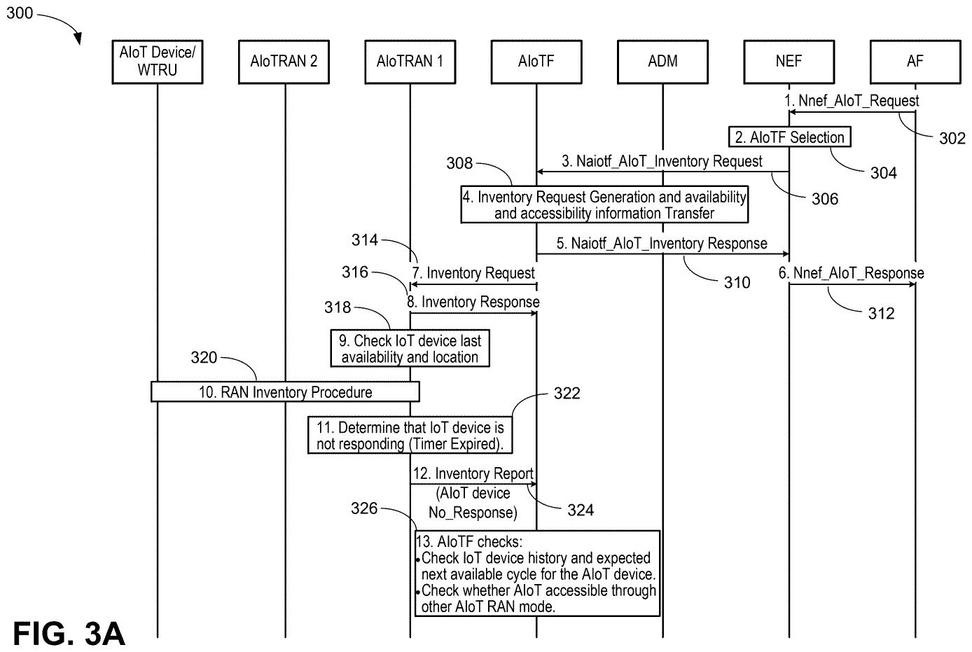

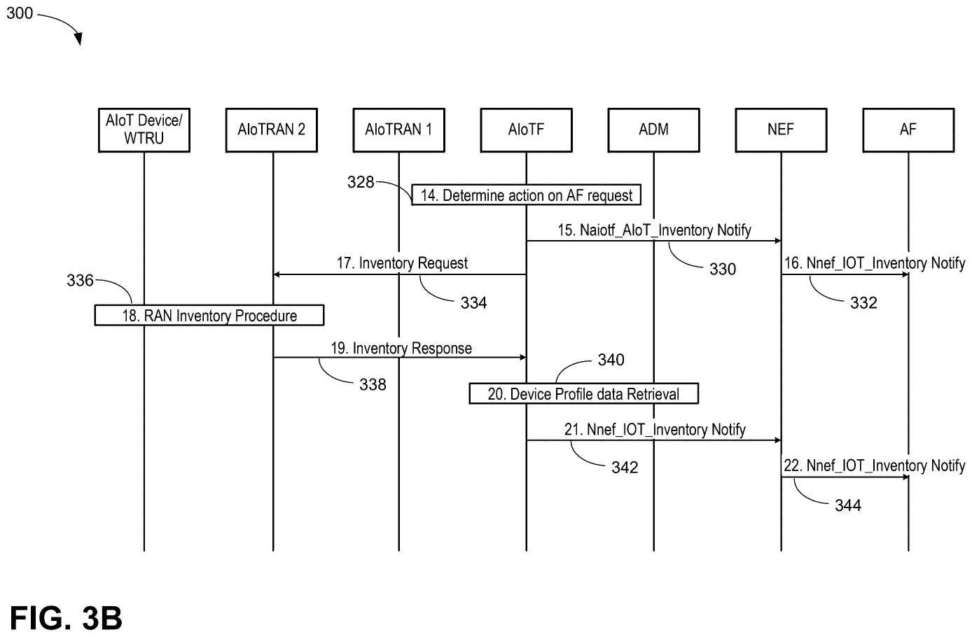

FIG. 3 is an example procedure 300 which may show how AIoTF may analyze AIoT device availability and/or reachability and decide whether the AIoT device may be expected to respond to the AF request within the maximum response delay and/or whether selecting different AIoT RAN node may be needed to reach the AIoT device.

An AIoT device availability detection and prediction may be implemented. Procedure 300 is an example procedure for how network may predict the availability of the AIoT device(s) and/or determine whether additional inventory attempts should be performed when a first inventory attempt fails. At 302, the AF may send an inventory request to the NEF. The AF may invoke Nnef_AIoT_Inventory service operation request to the NEF. The request may have AIoT device identity information. The message may have AF identity, maximum response delay duration and/or AF request ID. The maximum response delay duration means the amount of time that the AF can wait for a response from the AIoT device on certain request before this response becomes unusable and/or not useful, and AF may consider other options to fulfil the request.

At 304, the NEF may select the AIoTF to handle the request. At 306, the AF and/or NEF may send an inventory request to the selected AIoTF. The message may have AIoT device identity, AF identity, AF request ID and/or AF request requirements (e.g., maximum response delay duration). The message may include the AIoT location information.

At 308, upon receiving the request from the AIoTF and/or NEF, the AIoTF may perform an inventory request generation with the ADM. The inventory request generation may include, for example, the AIoTF receiving the stored and/or observed AIoT device availability information from the ADM and/or reachability information. The information received from the ADM may be one or more of the following. For example, the information the AIoT may receive from the ADM may include the last time the device was recorded unavailable. The AIoTF may store and/or update this information in the ADM when an inventory procedure for the device has failed (e.g., no response is received). For instance, the AIoTF may store information in the ADM that indicates when a device failed to respond to an inventory request and was therefore assumed to be unavailable. The information the AIoTF may receive from the ADM may include the last time the device was recorded available. The information that the AIoTF receives may be called historical information. For example, the ADM may provide historical information to the AIoTF. The historical information may include information about previous attempts to perform an inventory procedure with the AIoT device. For instance, the historical information may include information about the AIoT device's location when a successful inventory procedure was performed and the times at which the successful inventory procedure was performed. The historical information may include information about the locations where an attempt to perform an inventory procedure was unsuccessful and/or the times at which the unsuccessful inventory procedure was attempted. The historical information may include information about the properties of the AIoT device. For example, the information about the properties of the device may include how long it should take the AIoT device to recharge its energy storage after an inventory procedure and/or after any event where the AIoT device communicates and/or performs action. In some examples, the AIoTF may query the ADM to check if the AF is permitted and/or authorized, to trigger an inventory procedure with the AIoT Device. The ADM may respond with an indication that the AF is permitted to trigger the inventory procedure. The ADM may provide historical information to the AIoTF.

The AIoTF may store and/or update this information in the ADM when a device inventory response is received. For example, the AIoTF may store information in the ADM that indicates when a device responded to an inventory request and was therefore assumed to be available. The information the AIoT may receive from the ADM may include whether the device is available or unavailable for certain period(s) of times (e.g., days of the week, time of the day, and/or periodical unavailability pattern, etc.). This information may have been stored in the ADM based in information that was provided by the AF and/or based on analytics information that was received from an NWDAF. The information the AIoT may receive from the ADM may include information about the average response time of this AIoT device. For instance, the AIoTF may calculate the time between the point that an inventory request is sent and that an inventory response is received and inform the ADM about this information. The ADM may generate the statistics information (e.g., average response time) based on the response time received on different occasions. The information the AIoT may receive from the ADM may include a list of reader(s) used to reach the AIoT device before. The list may include the reader(s) identities and/or the reader(s) location(s). The list may include the time and/or date when each reader in the list was used to communicate with the device. If the AIoT service operation request cannot be processed, the AIoTF may reject the AIoT service operation request with an appropriate cause code, and step 314 and onward may be skipped. For example, the AIoTF may reject the request if the AIoT device identity is not recognized and/or if the AF is not authorized to inventory the AIoT device.

At 310, the AIoTF may send an AIoT inventory service response to the NEF. The response may contain the accept and/or reject result for the AIoT inventory service operation request based on step 308. This message may include an estimated time for the completion of the inventory procedure (e.g., an estimate of how long it would take to receive a response from the AIoT device). The AIoTF may be able to determine the estimated time for the completion of the inventory procedure based on the information that was received from the ADM in step 308. For example, the AIoTF may determine that, since the device responded to an inventory request one hour ago and since the device takes four hours to recharge, considering this info is known to the AIoTF, it is likely to take at least three hours to receive a response from the AIoT device.

At 312, the inventory response may be forwarded to the AF by the NEF. The response may have the accept and/or reject result for the AIoT Inventory service operation request. At 314, the AIoTF may send an inventory request to the AIoT RAN1. The message may have the AIoT device identity. The message may have values associated with the request timer. The AIoTF may use the AIoT location information that was received from the AF to determine what AIoT RAN (e.g., AIoT RAN1) to send this inventory requires to. At 316, the AIoT RAN1 node on reception of an inventory request from the AIoTF may send an inventory response to the AIoTF. The message may have an indication that the inventory request is received, and/or it will be executed.

At 318, the AIoT RAN1 may check if the AIoT device location information is received in the inventory request message in step 316. The AIoT RAN1 may check if any location information is stored internally for the AIoT device in the node from previous communication. The AIoT RAN1 may check if any availability information is stored for the AIoT device in the node such as, information about last communication between the node and/or AIoT device and/or whether AIoT device was available. The AIoT device location information may be used by the AIoT RAN to determine where to transmit the inventory request (e.g. what cells to transmit the request on, what direction to transmit the request in, and/or with how much to transmit the request).

At 320, the AIoT RAN1 may send an inventory request to the AIoT device. The message may have the AIoT device ID. At 322, the AIoT RAN1 may determine that the AIoT device is not responding. The determination may be based on the expiration of a timer. The timer value may be received from the AIoTF at 314. For example, at 314, the AIoTF may indicate to the AIoT RAN1 how long the AIoT RAN1 node should wait for a response. At 324, the AIoT RAN1 may send an inventory report to the AIoTF. The report message may have the AIoT device ID and/or an indication that the AIoT device is not responding. The inventory report message might have an AF request ID. The report may indicate how long the AIoT RAN1 waited for a response for the device before determining that the inventory attempt was unsuccessful. The report may indicate in what locations the AIoT RAN1 performed the inventory attempt.

At 326, on the reception of the inventory report from the AIoT RAN1, the AIoTF may be triggered to determine and/or analyze the AIoT device availability and/or alternative routes to reach the AIoT device using the received information from the ADM at 308. The AIoT device may determine a second AIoT RAN that may be used to reach the AIoT device in the inventory procedure. If the report indicates that AIoT device is not responding, the AIoTF may perform one or more of the following. For instance, the AIoTF may check the received stored and/or observed AIoT device availability information to predict when the device becomes available next. The AIoTF may check if any availability pattern is available in the received information from ADM at 308 to predict the next availability of the AIoT device. The AIoTF may check if availability information from previous request or periods is received at 308 to predict the next availability of the AIoT device. The AIoTF may use the historical information that was obtained at 308 to determine what AIoT RAN node to send the inventory request to in step 332. In other words, the identity of AIoT RAN2 may be determined by using the location information that is in the historical information. For example, the location information may indicate that the AIoT device previously communicated via AIoT RAN2 or was previously near AIoT RAN2. The AIoTF may check if the received information at 308 has information regarding that average response time and/or response time for previous requests. This might be used by the AIoTF to predict the average response time for the current request. The AIoTF may compare the expected average time of response with the received request of AF maximum response delay duration parameter. The AIoTF may check if provided information by the ADM at 308 has identity(s) of recent reader(s) used to communication with the AIoT device. This may be used by the AIoTF to select alternative reader, if AIoTF decides to send another inventory request to the AIoT device. The AIoTF may check if provided information by the ADM at 308 has the device reachability state (e.g., reachable and/or unreachable). If the inventory report indicates that a response is received from the AIoT device, the AIoT device response may be forwarded to the NEF.

At 328, the AIoTF, based on the analysis at 326, may determine the next step regarding the inventory request. For example, the AIoTF may decide that the AIoT device may be expected to be unavailable for a period that exceeds the communicated maximum response delay duration by the AF. The AIoTF may inform the AF that AIoT device may be uncapable, in terms of availability, to reply to the AF request within the delay requirements. The AIoTF may decide that the AIoT device is expected to be available shortly and/or within a period less than the maximum response delay duration and/or the AIoT can initiate immediately a second inventory request. Based on this decision, the AIoTF may inform the AF that the AIoTF may send a second inventory request to AIoT device and send this request to the AIoT device through AIoT RAN. The AIoTF may decide that the AIoT device may be available through a different reader and/or AIoT RAN and/or AIoTF may need to initiate a second inventory request through different reader. Based on this decision, the AIoTF may inform the AF that the AIoTF device may send a second inventory request to AIoT device but through different AIoT RAN and may send this request to the new AIoT RAN.

At 330, the AIoTF may send an inventory notification message to the NEF. The message may have an indication regarding the next action that will be taken by the AIoTF regarding the AF request. For example, the AIoTF may send a second inventory request to the AIoT device using a different AIoT RAN node. This message may have an indication that the AIoT device is unavailable, and/or that the Inventory procedure has failed. The message may have the AIoT device ID and/or request ID. The message may have an indication that the AIoT device is not expected to fulfil the request requirements. The message may have an indication that the AIoTF might perform a second inventory procedure with the AIoT device (e.g., a via a different AIoT RAN node).

At 332, the inventory notification message may be sent to the AF by the NEF. At 334, the AIoTF may send an inventory request to the AIoT RAN2. The message may have the AIoT device identity, AF Identity and/or AF request ID. At 336, upon reception of the inventory request message from the AIOTF, the AIoT reader(s) may execute the inventory procedure. The AIoT RAN2 may send the inventory request to the AIoT device and/or receive an inventory response from the AIoT device as part of the inventory procedure. At 338, upon receiving the response from the AIoT device, AIoT RAN 2 may send one or more inventory report messages to the AIoTF, wherein the message may have the AIoT device response and/or AF request ID.

At 340, the AIoTF may validate the AIoT device identity, using locally stored device information and/or device profile data retrieved from the ADM. The AIoTF may aggregate the results. The AIoTF may update the information described at 308 with the ADM, such as the last availability information, response time, and/or AIoT RAN node ID, etc. In some examples, the AIoTF may send to the ADM information regarding, for example, AIoT device availability, such as last availability time. The AIoTF may send to the ADM information regarding response time. The AIoTF may send to the ADM information regarding reachability information, such as the ID of the loT RAN used to reach the AIoT device. The ADM may store this information. The information that is stored may be called historical information. In some examples, the AIoTF may send information to the ADM about the successful and unsuccessful inventory attempts to the ADM. The transmitted information may include the location of successful and/or unsuccessful attempts. The location information may be the identity of the AIoT RAN nodes. The transmitted information may include the time and/or date of the successful inventory attempt.

At 342, the AIoTF may report the result of the AIoT inventory request to the NEF by sending the AIoT_Notify message including a list of AIoT device ID(s). At 344, the NEF may inform the AF of the outcome of the AIoT_Inventory request by sending the AIoT_Notify message including the AIoT device ID(s).

In some examples, availability information may refer to information about the times of day, days of the year, and/or time periods when a device is able and/or not able to receive a message from the network and/or information about in what locations a device is able and/or not able to receive a message from the network. The location information may be described as geographical location information, cell identifiers, reader identifiers, AIoT RAN identifiers, and/or network identifiers. Availability context may refer to any context and/or condition (e.g., weather, how close the AIoT device is to other devices, etc.) for the AIoT device to be able and/or not able to receive messages from the network. Availability information may also be called availability context.

Device availability state may refer to whether a device is in a reachable state and/or an unreachable state. If the device is able to receive a message, then the device may be considered reachable. If the device is unable to receive a message, then the device may be considered unreachable. A device may be unable to receive a message because the device is not configured to listen for a message and/or because the device does not have access to a sufficient amount of stored energy to receive and process information.

1. A first network device comprising:
a processor configured to:
receive a first inventory request, wherein the first inventory request identifies an ambient internet of things (AIoT) device and location information associated with the AIoT device;
send a message to an AIoT data management (ADM) function to determine whether a second network device is permitted to trigger an inventory procedure with the AIoT device;
receive, from the AIoT ADM function, an indication that the second network device is permitted to trigger the inventory procedure with the AIoT device;
receive, from the AIoT ADM function, historical information associated with the AIoT device, wherein the historical information comprises information about previous attempts to perform the inventory procedure with the AIoT device;
determine a first radio access network (RAN) node for accessing the AIoT device based on the historical information associated with the AIoT device; and
send a second inventory request to the first RAN node, wherein the second inventory request comprises an identifier associated with the AIoT device.

2. The first network device of claim 1, wherein the location information indicates one or more locations where the AIoT device is expected to be located.

3. The first network device of claim 1, wherein the location information comprises a cell identifier associated with where the AIoT device is expected to be located, an AIoT RAN node identifier associated with where the AIoT device is expected to be located, or a geographical information associated with where the AIoT device is expected to be located.

4. The first network device of claim 1, wherein the historical information associated with the AIoT device comprises information associated with a location of the AIoT device when a successful inventory procedure was performed and a time at which the successful inventory procedure was performed.

5. The first network device of claim 1, wherein the historical information associated with the AIoT device comprises information associated with a location of the AIoT device where an attempt to perform the inventory procedure was unsuccessful and a time at which the unsuccessful inventory procedure was attempted.

6. The first network device of claim 1, wherein the historical information associated with the AIoT device comprises information associated with properties of the AIoT device; and
wherein the information associated with properties of the AIoT device comprises an indication of how long it should take the AIoT Device to recharge its energy storage after the inventory procedure or after any event where the AIoT Device communicates or perform action.

7. The first network device of claim 1, wherein the processor is further configured to:
perform an inventory request generation with the AIoT ADM function, wherein the inventory request generation comprises one or more of last time the AIoT device was recorded unavailable, last time the AIoT device was recorded available, whether the AIoT device is available or unavailable for certain period(s) of times, information about average response time of the AIoT device, or list of reader(s) used to reach the AIoT device previously.

8. The first network device of claim 7, wherein the processor is further configured to:
send a third inventory request to a second RAN node; and
receive a message from the second RAN node, wherein the message from the second RAN node indicates that the AIoT device is not responding.

9. The first network device of claim 8, wherein the processor is further configured to:
predict when the AIoT device will be available, wherein the prediction is based on the historical information and an availability information received in the inventory request generation from the AIoT ADM function.

10. The first network device of claim 1, wherein the processor is further configured to:
send an indication to a network exposure function (NEF), wherein the indication comprises an AIoT device identity and an application function (AF) request ID.

11. A method performed by a first network device, the method comprising:
receiving a first inventory request, wherein the first inventory request identifies an ambient internet of things (AIoT) device and location information associated with the AIoT device;
sending a message to an AIoT data management (ADM) function to determine whether a second network device is permitted to trigger an inventory procedure with the AIoT device;
receiving, from the AIoT ADM function, an indication that the second network device is permitted to trigger the inventory procedure with the AIoT device;
receiving, from the AIoT ADM function, historical information associated with the AIoT device, wherein the historical information comprises information about previous attempts to perform the inventory procedure with the AIoT device;
determining a first radio access network (RAN) node for accessing the AIoT device based on the historical information associated with the AIoT device; and
sending a second inventory request to the first RAN node, wherein the second inventory request comprises an identifier associated with the AIoT device.

12. The method of claim 11, wherein the location information indicates one or more locations where the AIoT device is expected to be located.

13. The method of claim 11, wherein the location information comprises a cell identifier associated with where the AIoT device is expected to be located, an AIoT RAN node identifier associated with where the AIoT device is expected to be located, or a geographical information associated with where the AIoT device is expected to be located.

14. The method of claim 11, wherein the historical information associated with the AIoT device comprises information associated with a location of the AIoT device when a successful inventory procedure was performed and a time at which the successful inventory procedure was performed.

15. The method of claim 11, wherein the historical information associated with the AIoT device comprises information associated with a location of the AIoT device where an attempt to perform the inventory procedure was unsuccessful and a time at which the unsuccessful inventory procedure was attempted.

16. The method of claim 11, wherein the historical information associated with the AIoT device comprises information associated with properties of the AIoT device; and
wherein the information associated with properties of the AIoT device comprises an indication of how long it should take the AIoT Device to recharge its energy storage after the inventory procedure or after any event where the AIoT Device communicates or perform action.

17. The method of claim 11, wherein the method further comprises:
performing an inventory request generation with the AIoT ADM function, wherein the inventory request generation comprises one or more of last time the AIoT device was recorded unavailable, last time the AIoT device was recorded available, whether the AIoT device is available or unavailable for certain period(s) of times, information about average response time of the AIoT device, or list of reader(s) used to reach the AIoT device previously.

18. The method of claim 17, wherein the method further comprises:
sending a third inventory request to a second RAN node; and
receiving a message from the second RAN node, wherein the message from the second RAN node indicates that the AIoT device is not responding.

19. The method of claim 18, wherein the method further comprises:
predicting when the AIoT device will be available, wherein the prediction is based on the historical information and an availability information received in the inventory request generation from the AIoT ADM function.

20. The method of claim 11, wherein the method further comprises:
sending an indication to a network exposure function (NEF), wherein the indication comprises an AIoT device identity and an application function (AF) request ID.
